(19) United States
(12) Patent Application Publication
(10) Pub. No.: US 2009/0264328 A1
(43) Pub. Date: Oct. 22, 2009

(54) COMPOSITIONS

(75) Inventors: Venkateswara Kumar Vedantam, Paramus, NJ (US); Janardhanan Mahalingam, Singapore (SG); Jee Ting Nicholas Wong, Shanghai (CN); Markus Gautschi, Zeiningen (CH)

Correspondence Address: NORRIS, MCLAUGHLIN & MARCUS, 875 THIRD AVE, 18TH FLOOR, NEW YORK, NY, 10022, US

(73) Assignee: GIVAUDAN SA, Vernier (CH)

(21) Appl. No.: 11/574,027

(22) PCT Filed: Jul. 25, 2005
(86) PCT No.: PCT/CH05/00437

§ 371 Date: May 14, 2007

(30) Foreign Application Priority Data
Aug. 31, 2004 (GB) 0419266.2

(51) Int. Cl. C11D 9/44; C11D 3/37

(52) U.S. Cl. 510/103; 510/106; 510/102; 510/105; 510/350

(57) ABSTRACT

A surfactant composition comprising: (a) a surfactant material; (c) a polyethylene imine of the general formula —(CH₂CH₂NH)ₙ—; and (d) an aromatic, monoethylenically-unsaturated carboxylic acid ester of the formula (I) where R¹ is selected from the group consisting of hydrogen, C₁-C₁₆ alkyl, C₁-C₁₆ alkoxy, aryl and substituted aryl, and R² is selected from the group consisting of aryl, substituted aryl and C₆-C₁₆ alkyl; the materials (b)-(d) each having an odour value of 10,000 maximum. The problem of rancidity, commonly encountered when low-grade surfactant materials are used, especially in soaps, is considerably reduced.

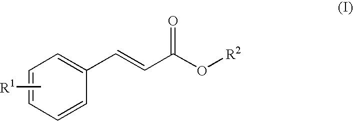

This invention relates to surfactant compositions, especially those for washing and treating substrates and to methods of preventing undesirable odours as a result of their use.

In this description, the use of the term “surfactant composition” means any composition comprising materials having affinity for both aqueous and non-aqueous phases when used in conjunction with water in a cleaning application, including the washing and conditioning of substrates. These materials can be the synthetic surfactants (anionic, cationic and non-ionic) widely used, and also the more traditional materials such as saponified animal and vegetable fats. Examples include washing detergents, fabric conditioners, and soaps of all kinds.

In this description, the use of the term “substrates” means any surface that may require washing or conditioning and includes fabric, textile, skin, hair, glass, ceramic etc.

In many parts of the world, surfactant compositions use low quality raw materials, which have an unpleasant odour and which can impart this unpleasant odour to the substrate being treated. In particular, bars of soap used for washing clothing, textiles, skin, hair, cooking utensils, and dishes, are often made from relatively cheap materials, typically materials derived from animal and vegetable fats. A problem universally encountered with such products is malodor. This is provoked by various factors, such as heat, humidity and presence of other additives, and it may develop and become worse over time. This can be overcome by the addition of perfume to counteract the malodour, but this solution is not only expensive but also not always effective.

It has now been found that this problem may be substantially or even completely overcome by the use of a particular formulation, in that the malodour can be counteracted and even a pleasant odour can be imparted, without the need for a perfume addition. The invention therefore provides a surfactant composition comprising:

(a) a surfactant material;
(b) a polyethylene imine of the general formula —(CH₂CH₂NH)ₙ—; and
(c) an aromatic, monoethylenically-unsaturated carboxylic acid ester of the formula

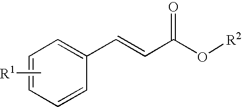

where R¹ is selected from the group consisting of hydrogen, C₁-C₁₆ alkyl, C₁-C₁₆ alkoxy, aryl and substituted aryl, and R² is selected from the group consisting of aryl, substituted aryl and C₆-C₁₆ alkyl; the materials (b) and (c) each having an odour value of 10,000 maximum.

The use of the singular in the definition shown above also includes the plural.

The parameter of Odour Value (hereinafter “OV”) is well known to the art. It is determined by the method of Neuner and Etzweiler, and is described in the standard reference work “Perfumes: Art, Science and Technology” (Elsevier, 1991) at p. 153. Preferably the materials (b) and (c) have an OV of less than 5,000, more preferably less than 2,000 and most preferably less than 1000.

Polyethylene imines are materials composed of ethylene imine units —CH₂CH₂NH—. The chains may be branched, in which case the hydrogen on the nitrogen is replaced by another chain of ethylene imine units. Polyethylene imines are water-soluble and are used in a variety of commercial applications. Examples of commercially-available polyethylene imines useful in this invention include the range sold under the trade name LUTPASOL (ex BASF). These are available in various grades, with molecular weights from 800 to 2 mio. Da. The same OVs as for aldehydes apply to the polyethylene imines.

The esters of the formula hereinabove depicted may be any such esters. Preferably R¹ is hydrogen, C₁₋₈ alkyl, C₁₋₈ alkoxy or aryl, and independently of this, R² is preferably C₆₋₁₂ alkyl or aryl.

By “surfactant material” is meant any substance or combination of substances that are useful for cleansing and conditioning substrates, when used in conjunction with water. This definition comprehends not only the surfactant blends used in laundry and dishwashing detergents and softening and conditioning agents, but also the more traditional soap raw materials, such as saponified natural oils. This invention may be used in conjunction with any of these, but it is especially useful with low-grade soap materials of the type often used in laundry bar soaps in parts of Asia and Latin America. Such materials are particularly prone to malodour over time and the use of this invention considerably reduces this; and may even eliminate it completely.

The surfactant compositions of this invention may also use any of the known materials used by the art in wash and treatment compositions, in art-recognised quantities. One preferred such material is solvent; it is preferred that the materials (b) and (c) are first dissolved in solvent prior to their addition to the surfactant material, as this makes their incorporation easier. Typical solvents include dipropylene glycol, diethyl phthalate, isopropyl myristate and benzyl benzoate.

In an especially preferred embodiment of the invention, the compositions additionally include a fragrant aldehyde, whose OHV has a value of 10,000 maximum, preferably less than 5,000, more preferably less than 2,000 and most preferably less than 1000.

A list of aldehydes, suitable for use in this invention, is shown below; this list is exemplary only and other aldehydes not shown here are also suitable for use in the invention.

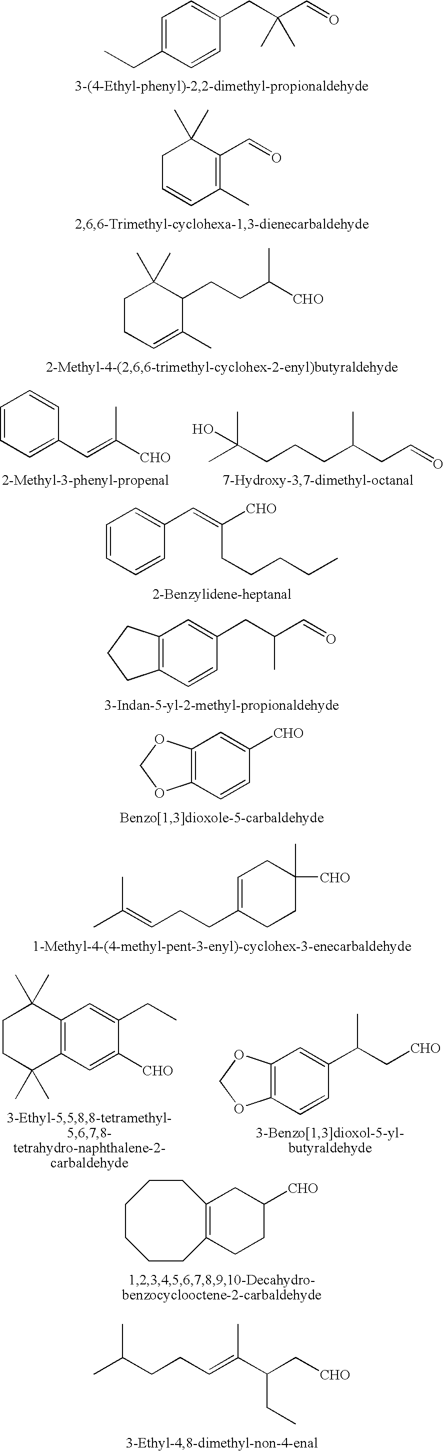

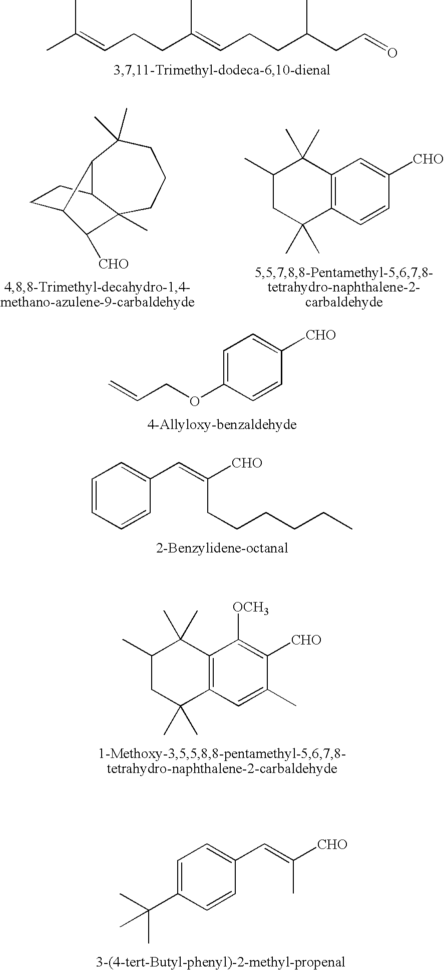

Another known material that may be used is fragrance. Although this invention can eliminate completely malodour and even itself impart a pleasing odour, it may be desirable to impart a particular fragrance to the composition. This may be done by using one or more of the many fragrances known to the art, in art-recognised quantities. One of the advantages of this invention is that, with the reduction or elimination of malodour, less perfume (an expensive component) is necessary to achieve a desired effect. The fragrances are generally solutions in organic solvent, and they may be added to the mixture of materials (b) and (c) and solvent hereinabove mentioned.

Other art-recognised ingredients, such as builders, buffers, fillers, antistatic agents, fungicides, antioxidants, dyes, pigments, fluorescing agents, bactericides and skin emollients, may also be used in art-recognised quantities.

The compositions of the invention are prepared by mixing the ingredients in the known manner. As hereinabove described, it is preferred to mix materials (b) and (c) first, with aldehyde, when required, preferably with solvent, and then mix this mixture into material (a), to give a composition according to the invention. The proportions should be such that

(i) when no fragrant aldehyde is present, the composition will contain a minimum concentration by weight of each of (b) and (c) of from 0.005%-0.5%.

(ii) when at least one fragrant aldehyde is present, (b) and (c) are each present in the composition to the extent of from 0.005%-10%.

Preferably

(iii) when fragrance is present, materials (b)+(c), +aldehyde, where present, are each present to the extent of from 0.001-5.0% by weight of materials (a)+(b)+(c)+aldehyde; and

(iv) when no fragrance is present, materials (b)+(c), +aldehyde, where present, are each present to the extent of from 0.01-2.0% by weight of materials (a)+(b)+(c)+aldehyde.

By substantially or even completely overcoming the problem of rancidity frequently encountered with low-grade laundry materials, the invention allows their use in a much wider range of applications. The invention therefore provides a composition for the reduction of rancidity in laundry materials prone thereto, the composition comprising:

(a) a polyethylene imine of the general formula —(CH₂Cl₂NH)ₙ—; and
(b) an aromatic, monoethylenically-unsaturated carboxylic acid ester of the formula

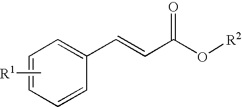

where R¹ is selected from the group consisting of hydrogen, C₁-C₁₆ alkyl, C₁-C₁₆ alkoxy, aryl and substituted aryl, and R² is selected from the group consisting of aryl, substituted aryl and C₆-C₁₆ alkyl; the materials (b) and (c) each having an odour value of 10,000 maximum.

Preferably the composition additionally contains fragrant aldehyde, as hereinabove described.

The invention further provides a method of reducing rancidity in a laundry material prone thereto, comprising the addition thereto of a composition consisting essentially of

(a) a polyethylene imine of the general formula —(CH₂CH₂NH)ₙ—; and
(b) an aromatic, monoethylenically-unsaturated carboxylic acid ester of the formula

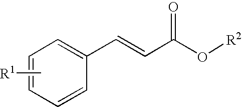

where R¹ is selected from the group consisting of hydrogen, C₁-C₁₆ alkyl, C₁-C₁₆ alkoxy, aryl and substituted aryl, and R² is selected from the group consisting of aryl, substituted aryl and C₆-C₁₆ alkyl; the materials (b)-(d) each having an odour value of 10,000 maximum.

Preferably there is also added fragrant aldehyde, as hereinabove described.

The invention is now further described with reference to the following non-limiting examples. In these examples, combinations of materials (b) and (c), and fragrant aldehyde were tested in different soap bases in the absence (examples 1-3) and in the presence (examples 4-6) of perfume.

### EXAMPLE 1

A mixture of 5% (wt) dihydrofarnesal (3,7,11-trimethyl-dodeca-6,10-dienal) (component (b)), 20% LUPASOL™ G 100 (50% active level, viscosity 1200 mPa-s, molecular weight (weight-average) 5000 (component (c)), 15% octyl methoxy cinnamate (component (d)), and 60% isopropyl myristate (60%) was prepared and added at a dosage of 0.2% by weight to soap bases as hereinunder described. The base was milled thoroughly and soap cakes made. The cakes were allowed to macerate for one day and evaluated olfactively. Soap cakes were made without the mixture and used as comparisons.

Evaluation was carried out on the strength of the fragrance note and how well the fragrance covered the base note. Various soap bases with strong to mild inherent base odours were evaluated by a panel and were given a rating as below:

| Perfume Strength | | Base Odour Coverage |
|---|---|---|
| Very Strong | 5 | Excellent Coverage |
| Strong | 4 | Very Good Coverage |
| Good | 3 | Good Coverage |
| Moderate | 2 | Weak Coverage |
| Weak | 1 | Base Odour Noticeable |

Base Odour Rating

| | without | with |
|---|---|---|
| | mixture | mixture |
| Soap Base 1 | 1.9 | 4.0 |
| Soap Base 2 | 2.0 | 4.1 |
| Soap Base 3 | 2.1 | 4.1 |
| Soap Base 4 | 1.9 | 4.0 |

Soap Base 1 was 100% soap base (usually contains about 15-20% water) of plant origin (usually referred to as 80/20, meaning made from 80% palm oil and 20% coconut oil).

Soap Base 2 was a mixture of soap base (90% Soap Base 1)+10% talc (this type of combination is usually used in making premium toilet soaps).

Soap Base 3 was a mixture of soap base (80% Soap Base 1)+20% talc (this type of combination is usually used in making mid-price toilet soaps).

Soap Base 4 was a mixture of soap base (60% Soap Base 1)+40% talc (this type of combination is usually used in making low-cost toilet soaps).

### EXAMPLE 2

A mixture of 10% dihydrofarnesal, 10% LUPASOL SK (25% active content, viscosity 500-1000 mPa-s and molecular weight 2,000,000), 5% geranyl crotanate and 75% dipropylene glycol was prepared and added at a dosage of 0.3% into soap bases of the types shown below. The base was milled thoroughly and soap cakes made. Soap cakes without the mixture were also made. The cakes were allowed to macerate for one day and evaluated olfactively as described in Example 1.

Base Odour Rating

| | without | with |
|---|---|---|
| | mixture | mixture |
| Soap Base 5 | 1.8 | 4.6 |
| Soap Base 6 | 2.1 | 4.5 |
| Soap Base 7 | 1.9 | 4.6 |
| Soap Base 8 | 1.9 | 4.6 |

Soap Base 5 was 100% soap base (usually contains about 15-20% water) of plant origin, prepared from a mixture of crude palm oil and palm fatty acid distillate.

Soap Base 6 was a mixture of soap base (90% Soap Base 5)+10% talc (this type of combination is usually used in making premium toilet soaps).

Soap Base 7 was a mixture of soap base (80% Soap Base 5)+20% talc (this type of combination is usually used in making mid-price toilet soaps).

Soap Base 8 was a mixture of soap base (60% Soap Base 5)+40% talc (this type of combination is usually used in making low-cost toilet soaps).

### EXAMPLE 3

A mixture of 10% dihydrofarnesal, 20% LUPASOL™ G 35 (50% active level, viscosity=450 mPa-s, average MW 2000), 20% dihexyl fumarate and 50% diethyl phthalate was prepared and added at a dosage of 0.1% into soap bases as described below and soap cakes made. Soap cakes without the mixture were also made. The cakes were allowed to macerate for one day and evaluated olfactively.

Base Odour Rating

| | without | with |
|---|---|---|
| | mixture | mixture |
| Soap Base 9 | 1.9 | 4.0 |
| Soap Base 10 | 2.0 | 4.1 |
| Soap base 11 | 2.1 | 4.1 |
| Soap base 12 | 1.9 | 4.0 |

Soap Base 9 was 100% soap base (usually contains about 15-20% water) of tallow origin.

Soap Base 10 was a mixture of soap base (90% Soap Base 9)+10% talc (this type of combination is usually used in making premium toilet soaps).

Soap Base 11 was a mixture of soap base (80% Soap Base 9)+20% talc (this type of combination is usually used in making mid-price toilet soaps).

Soap Base 12 was a mixture of soap base (60% Soap Base 9)+40% talc (this type of combination is usually used in making low-cost toilet soaps).

### EXAMPLE 4

A mixture of 5% dihydrofarnesal, 10% LUPASOL™ HF (50% active content, viscosity 14,000 mPa-s and molecular weight 50,000), 5% geranyl crotanate and 80% dipropylene glycol was prepared and mixed with a perfume (perfume 80%+mixture 20%). This mixture was dosed at 1.5% into soap bases as described hereinunder. The base was milled thoroughly and soap cakes made. The cakes were allowed to macerate for one day and evaluated olfactively. Control soap cakes (without the mixture and containing only the perfume at 1.5% dosage) were also made and tested.

| | Perfume Strength Rating | | Base Odour Coverage Rating | |
|---|---|---|---|---|
| | without | with | without | with |
| | mixture | mixture | mixture | mixture |
| Soap Base A | 4.2 | 4.8 | 2.1 | 4.7 |
| Soap Base B | 4.1 | 4.9 | 1.9 | 4.5 |
| Soap Base C | 4.1 | 4.9 | 1.9 | 4.8 |
| Soap Base D | 4.0 | 4.8 | 2.0 | 4.8 |

Perfume dosage in the soap base was 1.5% and the perfume contained 30% solvent. In the case of soaps to which the mixture was added, the proportion of solvent was reduced by the quantity of mixture present.

Soap Base A was made from 100% soap base (usually contains about 15-20% water) of plant origin (usually referred to as 80/20, meaning made from 80% palm oil and 20% coconut oil)

Soap Base B was made from a mixture of soap base (90% Soap Base 1)+10% talc (this type to of combination is usually used in making premium toilet soaps)

Soap Base C was made from a mixture of soap base (80% Soap Base 1)+20% talc (this type of combination is usually used in making mid-price toilet soaps).

Soap Base D was made from a mixture of soap base (60% Soap Base 1)+40% talc (this type of combination is usually used in making low-cost toilet soaps).

### EXAMPLE 5

A mixture of 15% dihydrofarnesal, 5% LUPASOL™ PS (33% active content, viscosity 1400 mPa-s and MW 750,000), 5% LUPASOL™ G 100 (50% active level, viscosity 1200 mPa-s, and average MW 5000), 5% octyl methoxy cinnamate, and 70% isopropyl myristate was prepared and mixed with a perfume (perfume 90%+mixture 10%). This mixture was dosed at 1.2% into soap bases as described hereinunder. The base was milled thoroughly and soap cakes made. The cakes were allowed to macerate for one day and evaluated olfactively. Control soap cakes (without the mixture and containing only perfume at 1.2% dosage) were also prepared and tested.

| | Perfume Strength Rating | | Base Odour Coverage Rating | |
|---|---|---|---|---|
| | without | with | without | with |
| | mixture | mixture | mixture | mixture |
| Soap Base E | 4.2 | 4.7 | 1.6 | 4.5 |
| Soap Base F | 4.0 | 4.9 | 1.9 | 4.6 |
| Soap Base G | 3.9 | 4.8 | 1.7 | 4.8 |
| Soap Base H | 3.6 | 4.9 | 2.0 | 4.8 |

Soap Base E was made from 100% soap base (usually contains about 15-20% water) of plant origin prepared from a mixture of crude palm oil and palm fatty acid distillate.

Soap Base F was made from a mixture of soap base (90% Soap Base 5)+10% talc (this type of combination is usually used in making premium toilet soaps).

Soap Base G was made from a mixture of soap base (80% Soap Base 5)+20% talc (this type of combination is usually used in malting mid-price toilet soaps).

Soap Base H was made from a mixture of soap base (60% Soap Base 5)+40% talc (this type of combination is usually used in making low-cost toilet soaps).

### EXAMPLE 6

A mixture of 5% dihydrofarnesal, 10% LUPASOL™ G 100 (50% active level, viscosity 1200 mPa-s, average MW 5000), 25% octyl methoxy cinnamate and 60% benzoyl benzoate was prepared and mixed with a perfume (perfume 85%+mixture 15%). This mixture was dosed at 1.6% into soap bases as described hereinunder. The base was milled thoroughly and soap cakes made. The cakes were allowed to macerate for one day and evaluated olfactively. Control soap cakes (without the mixture and containing only perfume at 1.6% dosage) were also made and tested.

| | Perfume Strength Rating | | Base Odour Coverage Rating | |
|---|---|---|---|---|
| | without | with | without | with |
| | mixture | mixture | mixture | mixture |
| Soap Base J | 4.5 | 4.9 | 2.1 | 4.5 |
| Soap Base K | 4.6 | 4.9 | 1.9 | 4.6 |
| Soap Base L | 4.4 | 4.8 | 1.8 | 4.8 |
| Soap Base M | 4.6 | 4.9 | 2.0 | 4.8 |

Soap Base J was 100% soap base (usually contains about 15-20% water) of tallow origin.

Soap Base K was made from a mixture of soap base (90% Soap Base 9)+10% talc (this type of combination is usually used in making premium toilet soaps).

Soap Base L was made from a mixture of soap base (80% Soap Base 9)+20% talc (this type of combination is usually used in making mid-price toilet soaps).

Soap Base M was made from a mixture of soap base (60% Soap Base 9)+40% talc (this type of combination is usually used in making low-cost toilet soaps).

### EXAMPLE 7

A translucent personal wash soap base that had a fatty malodor had the following respective ingredients in the table below mixed in and the mass was milled, extruded and stamped in the form of a bar. One litre of headspace off the bar was taken at a rate of 100 ml a minute for 10 minutes and analyzed by gas chromatography and mass spectrometry.

The malodor components were identified and their level quantified. The color of the bars were assessed a 5 point scale by where 1=no coloration 5=strong brown color. The results were:

| | % Headspace | |
|---|---|---|
| | Reduction | Coloration |
| Control | 0 | 1 |
| soap base plus 0.1% LUPASOL ™ FG | 61 | 2 |
| soap base plus 0.2% LUPASOL FG | 66 | 4 |
| soap base plus 0.2 DHF | 32 | 1 |
| soap base plus 0.10% LUPASOL + 0.10% | 70 | 3 |
| DHF | | |
| soap base plus 0.05% + 0.15% DHF | 83 | 2 |
| soap base plus 0.05% + 0.135% DHF + | 76 | 2 |
| 0.015% GC | | |

Where DHF = dihexyl fumarate and GC = geranyl crotonate

LUPASOL™ FG alone provides a significant reduction in the malodor of the soap base. However the soap is an unacceptable yellow brown color. The benefit of LUPASOL can be improved and the color minimized to an acceptable level by using it in combination with dihexyl fumarate or a mixture of dihexyl fumarate and geranyl crotonate

### EXAMPLE 8

The soap base of Example 7 had added thereto 1% of a commercial soap fragrance added, alone or with the combination of materials below. Samples were prepared and analysed as above.

| | % Headspace | |
|---|---|---|
| | Reduction | Coloration |
| soap base plus 1% fragrance − Control | 21 | 2 |
| soap base plus 1% fragrance + 0.2% | 87 | 4 |
| LUPASOL ™ FG | | |
| soap base plus 1% fragrance + 0.05% | 89 | 2 |
| LUPASOL FG + 0.15 DHF | | |
| soap base plus 1% fragrance + 0.10% | 91 | 3 |
| LUPASOL FG + 0.10 DHF | | |

LUPASOL alone significantly reduces the malodor in the presence of a fragrance; however, the color is unacceptable. In combination with dihexyl fumarate an acceptable color can be achieved and excellent the good malodor reduction obtained.

1. A surfactant composition comprising:
(a) a surfactant material;
(b) a polyethylene imine of the general formula —(CH₂CH₂NH)ₙ—; and
(c) an aromatic, monoethylenically-unsaturated carboxylic acid ester of the formula 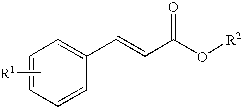
where R¹ is selected from the group consisting of hydrogen, C₁-C₁₆ alkyl, C₁-C₁₆ alkoxy, aryl and substituted aryl, and R² is selected from the group consisting of aryl, substituted aryl and C₆-C₁₆ alkyl; the materials (b) and (c) each having an odour value of 10,000 maximum.

2. A surfactant composition according to claim 1, in which R¹ is selected from hydrogen, C₁₋₈ alkyl, C₁₋₈ alkoxy and aryl.

3. A surfactant composition according to claim 1, in which R² is selected from C₆₋₁₂ alkyl and aryl.

4. A surfactant composition according to claim 1, in which the composition additionally comprises a fragrant aldehyde having an odour value of 10,000 maximum, preferably less than 5,000, more preferably less than 2,000 and most preferably less than 1000.

5. A surfactant composition according to claim 1, in which
(i) when at least one fragrant aldehyde is present, (b) and (c) are each present in the composition to the extent of from 0.005%-10%; and
(ii) when no fragrant aldehyde is present, the composition will contain from 0.005%-0.5% of each of (b) and (c).

6. A surfactant composition according to claim 4, in which the fragrant aldehyde is selected from the group consisting of the following compounds:

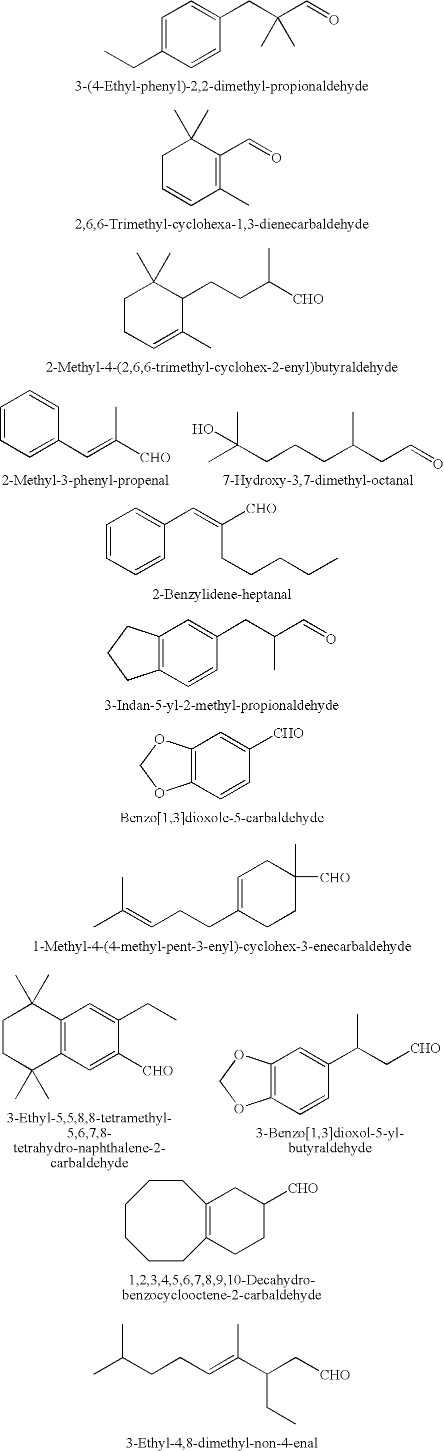

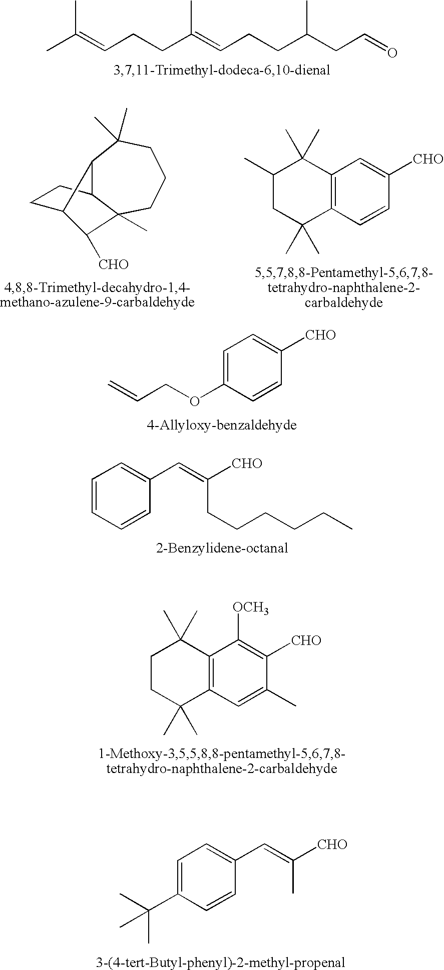

7. A composition for the reduction of rancidity in laundry materials prone thereto, the composition comprising:
(a) a polyethylene imine of the general formula —(CH₂CH₂NH)ₙ—;
(b) an aromatic, monoethylenically-unsaturated carboxylic acid ester of the formula 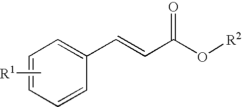
where R¹ is selected from the group consisting of hydrogen, C₁-C₁₆ alkyl, C₁-C₁₆ alkoxy, aryl and substituted aryl, and R² is selected from the group consisting of aryl, substituted aryl and C₆-C₁₆ alkyl;
and optionally a fragrant aldehyde;
the materials (b) and (c) and, where present, the fragrant aldehyde each having an odour value of 10,000 maximum.

8. A method of reducing rancidity in a surfactant material prone thereto, comprising the addition thereto of a composition consisting essentially of
(a) a polyethylene imine of the general formula —(CH₂CH₂NH)ₙ—; and
(b) an aromatic, monoethylenically-unsaturated carboxylic acid ester of the formula 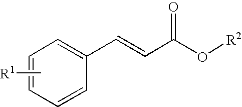
where R¹ is selected from the group consisting of hydrogen, C₁-C₁₆ alkyl, C₁-C₁₆ alkoxy, aryl and substituted aryl, and R² is selected from the group consisting of aryl, substituted aryl and C₆-C₁₆ alkyl;
and optionally a fragrant aldehyde,
the materials (b) and (c) and, when present, the aldehyde, each having an odour value of 10,000 maximum.

9. A surfactant composition according to claim 4, in which
(i) when at least one fragrant aldehyde is present, (b) and (c) are each present in the composition to the extent of from 0.005%-10%; and
(ii) when no fragrant aldehyde is present, the composition will contain from 0.005%-0.5% of each of (b) and (c).
